(19) United States
(12) Patent Application Publication
(10) Pub. No.: US 2005/0180703 A1
(43) Pub. Date: Aug. 18, 2005

(54) Method and device for splicing optical waveguides

(76) Inventor: Gervin Ruegenberg, Munich (DE)

Correspondence Address: Corning Cable Systems, Post Office Box 489, Hickory, NC, 28603, US

(21) Appl. No.: 10/508,752

(22) PCT Filed: Mar. 21, 2003
(86) PCT No.: PCT/DE03/00949

(30) Foreign Application Priority Data
Mar. 21, 2002 (DE) 10212716.6

(51) Int. Cl. G02B 6/255

(52) U.S. Cl. 385/96

(57) ABSTRACT

The invention concerns a process and a device for the splicing of optical fibers. At least one laser beam is directed to the optical fibers for the thermal splicing of at least two optical fibers. According to the invention, the position of an impingement point of each and every laser beam onto the optical fibers is periodically changed in the longitudinal direction of the optical fibers to be spliced for the impact of the power density profile onto the optical fibers to be spliced.

### CROSS REFERENCE TO RELATED APPLICATIONS

This application is the National Stage of International Application No. PCT/DE03/00949, filed Mar. 21, 2003. The International application was not published in English under PCT Article 21(2) and claims the benefit of German Patent Application No. 102 12 716.6, filed Mar. 21, 2003.

### FIELD OF THE INVENTION

The invention concerns a process and device for the splicing of optical fibers.

### BACKGROUND OF THE INVENTION

The invention concerns the thermal splicing of optical fibers. Current splicing devices as a rule use an electrical glow discharge for an energy source for the splicing process. During the splicing process the optical fibers to be spliced are located in an impact zone of this glow discharge and are thus heated to the melting point. The quality of the splice connected achieved depends, among other parameters, on the intensity of heating of the optical fibers as well as the size of the heating zone. These two parameters cannot be controlled independently from each other due to the splicing device based on the principle of glow discharge. The essential control parameters available for such splicing devices are the current, which drives the glow discharge, and the distance of the splicing electrodes. A higher current results inevitably in a greater expansion of the glow discharge. The heating zone is thereby also increased. By varying the distance between the electrodes, the expansion of the heating zone can only be minimally influenced.

A process is known from the document U.S. Pat. No. 4,263,495 where a laser is used as the energy source instead of the glow discharge. For this process a focusing of the laser beam is carried out in order to obtain sufficient power density. The expansion of the heating zone for this process is determined by the focus setting.

With current splicing applications it is often necessary to splice together two different fibers. If, for example, the fibers to be spliced have markedly different mode field diameters, significant additional attenuation occurs if no other measures are taken. As a counter measure for the state-of-the-art processes a relatively long splicing time can be used in order to achieve an equalization of the mode field diameters by a diffusion of the core material. This results in a certain improvement, but this process does not offer sufficient degree of freedom in order to achieve optimal results. In order to ensure an optimal splicing process, the form of the heating zone or temperature profile along the optical fiber axis, respectively, must be able to be freely selected, independent from the heat output applied. This is not possible for state-of-the-art technology.

### SUMMARY OF THE INVENTION

Proceeding from this, the present invention has the objective to create a new type of process for the splicing of optical fibers, which makes it possible to influence the power density profile of the optical fiber heating at will and thus adjust optimally to the requirements.

This objective is achieved by a process and by a device with the characteristics of the inventions described and shown herein.

With this invention the diffusion processes in the optical fibers during splicing can be selectively controlled. Thus an optimal splicing process with attenuation values near the theoretically achievable minimum can be achieved.

### BRIEF DESCRIPTION OF THE DRAWINGS

Preferred further developments of the invention result from the accompanying drawings and the subsequent description. Exemplary embodiments of the invention are illustrated and further explained by means of drawings in which:

FIG. 1 is a principle sketch for clarification of a process according to the invention.

FIG. 2 illustrates various curves for clarification of the movement of a laser beam impingement point to the optical fibers to be spliced and curves for clarification of the power density profile of the optical fiber heating focused on the optical fibers to be spliced.

FIG. 3 illustrates a curve for clarification of the movement of a laser beam impingement point with several curves for clarification of the control of the laser output and curves for clarification of the power density profile of the optical fiber heating focused on the optical fibers to be spliced.

FIG. 4 is a panel diagram of a device according to the invention.

FIG. 5 illustrates an impingement point of a laser beam onto two optical fibers to be spliced together in a top view.

### DETAILED DESCRIPTION OF THE INVENTION

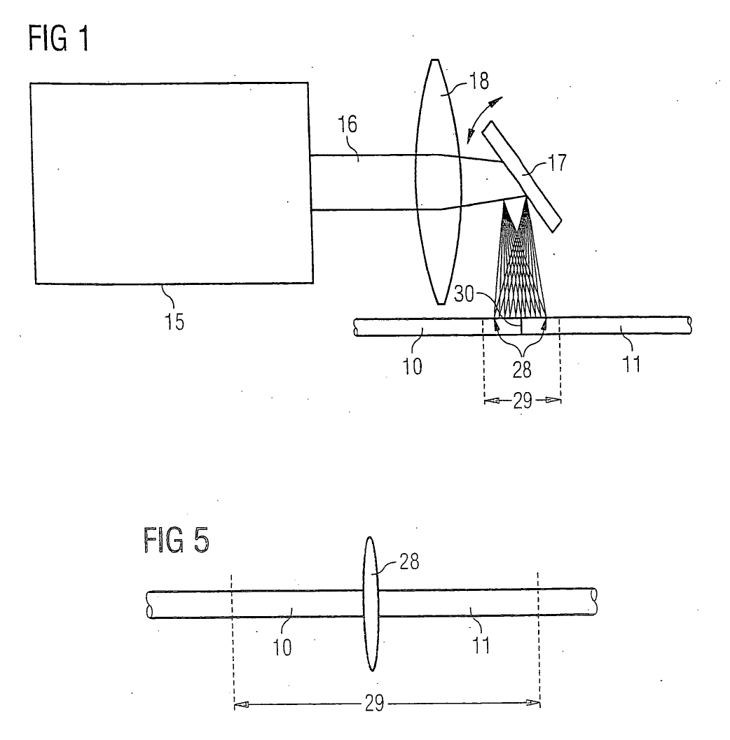

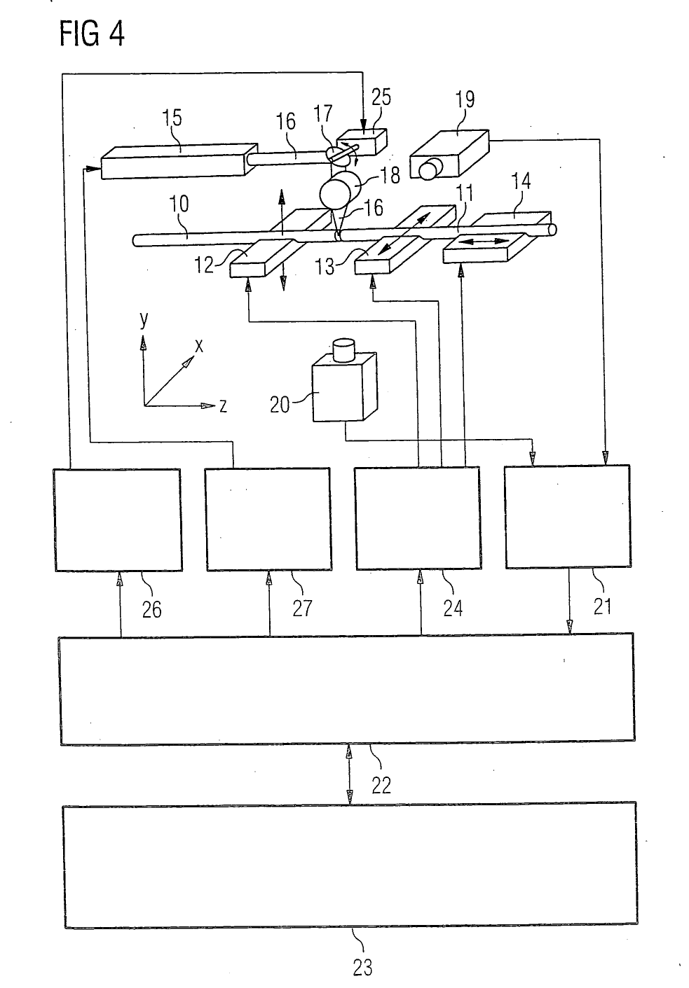

First, the construction of a device according to the invention for the splicing of optical fibers is clarified by reference to FIG. 4 and FIG. 1. According to FIG. 4, two optical fibers 10, 11 to be spliced together are arranged on the positioning elements 12, 13, 14, which enable a spatial alignment of the optical fibers 10, 11 in three axes each running vertically to each other. The optical fiber 11 is arranged on the positioning elements 13, 14, which can move the optical fiber 11 into a level running horizontally, stretching from the x-axis as well as the z-axis. The other optical fiber 10 is arranged on the positioning element 12. The optical fiber 10 can be moved by the positioning element 12 in the y-axis, which runs vertically to the x-axis and the z-axis. In this way the optical fibers 10, 11 to be spliced together can be maneuvered exactly toward each other for the splicing process.

As the energy source for the splicing process a laser 15 is provided, which beams a laser beam 16. The laser beam 16 reaches a mirror 17 and is thus steered in the direction of the optical fibers 10, 11 to be spliced. In place of the mirror other movable optical components can be used. Non-rotating components such as transparent prisms or cuboids can be considered.

For focusing the laser beam 16 a lens 18 is provided, which, in the beam path of the laser, is either arranged behind the mirror 17 (FIG. 4) or before the mirror (FIG. 1). The laser 15 is preferably a CO₂ laser.

The position of the optical fibers 10, 11 to be spliced together and the splicing process are monitored by the cameras 19, 20. The cameras 19, 20 forward the acquired signals to an acquisition unit 21, which evaluates the signals and forwards them to a central control unit 22. The central control unit 22 on its part is connected to an operator- and notification unit 23, so that the user can monitor the splicing process and if need be govern it by entry of control commands or splice parameters, respectively.

The central control unit 22 serves as the control or adjustment setting, respectively, of the total splicing process. It processes the data transmitted by the acquisition unit 21. If for example a change in the spatial alignment of the optical fibers 10, 11 to be spliced together is necessary, the central control unit 22 forwards control signals to a position control unit 24, which is coupled to all three positioning elements 12, 13, 14. This then causes a change of the spatial alignment of the optical fibers 10, 11 to be spliced together.

To ensure an optimal splicing process the temperature profile or the power density profile, respectively, along the axis of the optical fibers 10, 11 must be able to be selected independently from the applied power of the laser 15. For this purpose the mirror 17 has a driver unit 25, which aids the mirror 17 in changing its position. According to FIG. 1 and FIG. 4 the mirror 17 is swivel-mounted. For control of the pivoting of the mirror 17 a driver control unit 26 is allocated to the driver unit 25. The driver control unit 26 is coupled to the central control 22. Additionally, a laser control unit 27 is available, which enables the output of the laser 15 to be influenced. The laser control unit 27 is coupled on the one hand with the central control unit and on the other hand with the laser 15.

The process according to the invention for splicing of optical fibers 10, 11 is described in more detail below with reference to FIGS. 1-5.

According to the invention, an impingement point 28 of the laser beam 16 onto the optical fibers 10, 11 to be spliced together is changed in the longitudinal direction of the optical fibers 10, 11 to be spliced together. This is especially made clear in FIG. 1. The impingement point 28 is moved around a splicing point 30 of the optical fibers 10, 11 to be spliced together in a predetermined area 29.

It is preferable to move the impingement point 28 in the predetermined area 29 periodically, where a frequency for the movement of the impingement point 28 onto the optical fibers 10, 11 to be spliced together is determined in such a way, that the duration of a period for moving the impingement point 28 is much shorter than the thermal time constant of the optical fibers 10, 11 to be spliced together.

In this context it is important, that the focusing of the laser beam 16 is done in such a way, that a small impingement point and thus a relatively small heating zone is materialized. The impingement point must not be wider than the smallest heating zone appropriate for splicing. An appropriate width of the impingement point 28 is between 20 μm and 100 μm. Additionally, the focusing preferably proceeds in such a way, that an elongated impingement point 28 results in the optical fiber level, which has a greater elongation at a right angle to the axis of the optical fibers 10, 11 than along the axis (see FIG. 5). Instead of a round impingement point, a line-like or elliptical impingement point 28 results. This avoids excessive local heating of the optical fibers 10, 11. Tolerances between the position of the optical fibers 10, 11 and the location of the impingement point 28 can be adjusted. The desired form of the impingement point can be achieved by using cylinder lenses or appropriate lens combinations. The optimal width of the impingement point 28 results from the above mentioned requirements relative to the width of the heating zone. The height of the impingement point 28 should be selected in such a way, that the mechanical tolerances to be expected can be covered, i.e. one should avoid that the optical fibers 10, 11 are located at the edge of the impingement point or even outside of it.

As mentioned previously, the movement of the mirror occurs periodically and with a period duration which is much shorter than the thermal time constant of the fiber. This ensures, that the optical fibers over the total movement area of the impingement point are virtually heated at the same time. A preferred frequency for the movement of the mirror 17 lies between 50 Hz and 500 Hz. For control of the power density profile, the movement of the mirror 17 or the impingement point 28, respectively, and/or the output of the laser 15 or the laser beam 16, respectively, is being modulated.

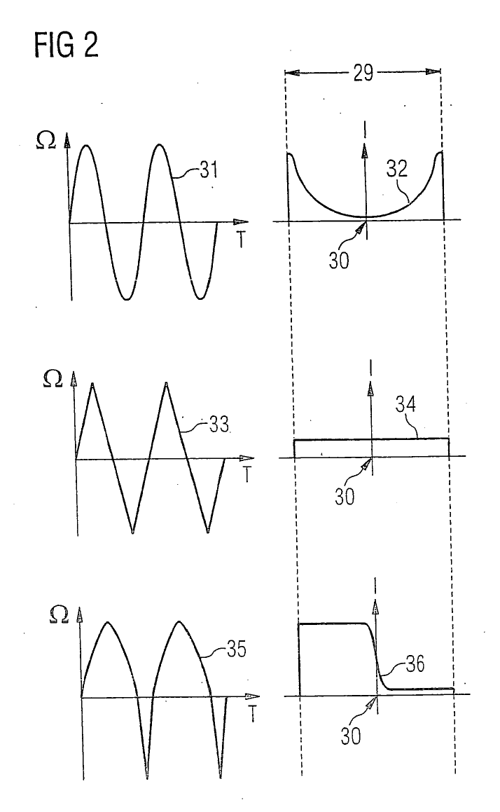

For modulation of the movement or the speed of the movement of the mirror 17 and the impingement point 28, respectively, the driver unit 25 of the mirror 17 is controlled in a curve form, which provides the desired heating profile or power density profile, respectively. The output of the laser 15 preferably remains constant. In the area of slow mirror 17 movement a higher part of the laser output is in effect compared to areas with faster movement. In this way the optical fibers are heated more in these areas. FIG. 2 shows this by means of three examples. With a sine-like movement Ω of the mirror 17 over time T according to curve 31 the power density with constant output of the laser 15 is greatest at the edges of the movement in area 29, since the movement of the mirror 17 is slowest there due to the reversal of the direction of the movement. The intensity profile I of the medium laser output results in the curve 32 depicted as a “bathtub curve”. The second example shows in the curve 33 a triangular movement Ω of the mirror 17. This leads to an even intensity profile I over the axis of the optical fibers 10, 11 to be spliced together with constant output of the laser 15 (see curve 34 in FIG. 2). In the third example (see curves 35 and 36) it is shown how an arbitrarily selected intensity profile I can be achieved through appropriate modulation of the mirror movement Ω. A left optical fiber is here heated significantly more than the right optical fiber, since the mirror movement is slower in this area. Such an asymmetrical intensity profile is especially advantageous if the two optical fibers 10, 11 to be spliced together have different characteristics, (e.g., different outer diameters). For modulation of the movement of the impingement point 38 a curve path of the movement of the impingement point 38 or the mirror 17, respectively, is changed with a predetermined constant for the movement of the impingement point 38.

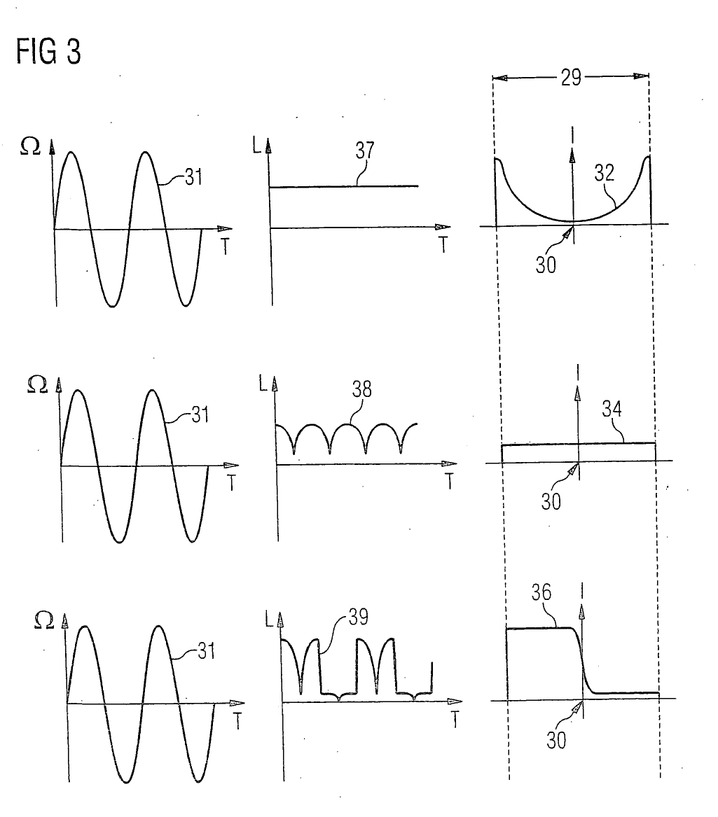

For the modulation of the intensity of the laser beam 16, an output L of the laser 15 is changed. The modulation of the laser 15 occurs hereby synchronized with the movement 106 of the mirror. The driver unit 25 of the mirror 17 is driven with a constant curve form (e.g., sine) and the above mentioned base frequency. The output L of the laser 15 is controlled or regulated in a synchronized way, so that the desired power density profile I results. FIG. 3 shows again three examples for this. The mirror 17 in these examples is moved according to curves 31 in a sine-like form, since this can be realized technologically in the simplest way. In the examples according to FIG. 3, the same power density profiles 32, 34, 36 are realized as in the examples according to FIG. 2. With constant laser output L (see curve 37) a power density profile in the previously mentioned “bathtub curve” is the result. In the second example, the laser output L according to curve 38 is modulated in such a way that it compensates for the speed differences of the movement Ω of the mirror 17. This again results in a constant power density profile I. In the third example this is the same, however, in the left part of the mirror movement a higher laser output L (see curve 39) than in the right part is selected. In this way the left optical fiber will be heated more than the right optical fiber.

The arrangement shown makes it possible to control the power density profile I of the laser beam 16 hitting the optical fibers 10, 11 at will. In this way the temperature profile can be set during the splicing process as necessary for optimal attenuation. In this way an optimal splicing process with minimum attenuation values is achieved. The control of the temperature profile over the modulation of the intensity of the laser beam 16 has the advantage over the control over the curve form of the movement, that fewer demands are made on the driver unit 25 of the mirror 17. Thus, for example, a triangular mirror movement according to curve 33 is technologically difficult and can only be approximately realized.

Therefore either the curve form of the mirror movement Ω or the laser output L is modulated. Of course, both of these actions can be combined as will be readily appreciated by one of ordinary skill in the art.

The movement of the laser beam 16 in the examples shown is accomplished with a periodically moving mirror 17 (a so-called galvanometer scanner). In its place a polygon scanner can be used. This is a rotating mirror with several mirror surfaces (e.g., side edges of a hexagon) arranged at regular intervals. This enables a high speed of the movement of the laser beam 16, since no reversal of movement is necessary. In this case the control of the intensity profile I can preferably be done over the modulation of the laser output L.

The process according to the invention can be used in the same way for simultaneous splicing of several optical fibers combined into a tape (so-called ribbon). In this case the bright spot is configured in such a way, that it covers the total width of the ribbon. There are two possibilities: In the first one an additional back and forth movement of the laser beam vertical to the axis is executed. For this in the simplest case a second movable mirror, preferably a polygon scanner, is provided. In this way the movement frequency for a second movement axis can be selected much higher than for the first axis. This avoids, that the overlap of the two movements leads to undesirable uneven heat distribution. In the second, the laser beam is expanded to a line by one or more cylinder lenses.

The bright spot thus produced has to be large enough vertical to the fiber axis, that the connecting points in the total ribbon are evenly heated.

The process according to the invention is also especially well suited for the splicing of optical fibers with different characteristics, especially different outer diameters. In such a case the use of an asymmetrical intensity profile I according to curve 36 is especially advantageous.

The process according to the invention can also be used for splicing of optical fibers to optical components (e.g., “chips”, wavelength multiplexers, couplers, etc).

For splicing optical fibers to optical components, one of the optical fibers to be spliced is an optical fiber within the optical component. Since it has a significantly higher heat capacity and heat dissipation than the other optical fiber, the use of an asymmetrical intensity profile I according to curve 36 is of special interest in this case. Therefore the process according to the invention here offers special advantages.

It is principally possible to use several laser beams instead of one laser beam for example, the laser beam can be divided into two partial beams by means of a beam splitter, which can both be directed onto the optical fibers. In such a case the invention can be used in the same way.

1. Process for splicing of optical fibers, where at least one laser beam (16) for thermal splicing of at least two optical fibers (10, 11) is directed to the optical fibers (10, 11), where a position of an impingement point (28) of each and every laser beam (16) onto the optical fibers (10, 11) in the longitudinal direction of the optical fibers (10, 11) to be spliced being changed by movement of each and every laser beam (16), so that the impingement point (28) is periodically moved in a predetermined area (29) around a splicing point (30) of the optical fibers (10, 11) to be spliced in their longitudinal direction, and that a frequency for the movement of the impingement point (28) onto the optical fibers (10, 11) to be spliced is calculated in such a way, that the duration of one period for the movement of the impingement point (28) is shorter than the thermal time constant of the optical fibers (10, 11) to be spliced.

2. Process according to claim 1, characterized by the movement of the impingement point (28) and or the intensity of the laser beam being modulated for the provision of an optimized output profile onto the optical fibers (10).

3. Process according to claim 2, characterized by a curve path or the speed of the movement of the impingement point (28), respectively, being changed for modulation of the movement of the impingement point (28) with a predetermined frequency for the movement of the impingement point.

4. Process according to claim 2 or 3, characterized by the output of a laser (15) being changed for the modulation of the intensity of the laser beam (16).

5. Process according to one of the claims 2 to 4, characterized by the modulation of the intensity of the laser beam (16) being synchronized with the modulation of the movement of the impingement point (28).

6. Device for splicing of optical fibers with a laser (15) for thermal splicing of at least two optical fibers (10, 11), with at least one lens (18) for focusing at least one of the laser beams (16) beamed from the laser (15) and with at least one optical component, especially a mirror (17) for pointing each and every laser beam (16) onto the optical fibers (10, 11) to be spliced, characterized by a driver unit (25) for each and every optical component, especially each and every mirror (17), where each and every optical component is movable in such a way by means of the driver unit (25), that a position of an impingement point (28) of each and every laser beam (16) onto the optical fibers (10, 11) to be spliced can be moved periodically in its longitudinal direction.

7. Device according to claim 6, characterized by a driver control unit (26) being allocated to the driver unit (25) for each and every movable optical component, especially for each and every mirror (17) for manipulation of a curve path or speed, respectively, of the movement of the impingement point (28).

8. Device according to claim 6 or 7, characterized by a laser control unit (27) being allocated to the laser (15) for modulation of the intensity of the laser beam (16).

9. Device according to claim 7 or 8, characterized by the driver control unit (26) and the laser control unit (27) being connected to a central control unit (22).
